(19) United States
(12) Patent Application Publication
(10) Pub. No.: US 2007/0256366 A1
(43) Pub. Date: Nov. 8, 2007

(54) Adjustable door seal

(75) Inventors: Michael Kwasnik, Dearborn, MI (US); Amiyo Basu, Canton, MI (US); Shaobo Young, Plymouth, MI (US); Gurpreet Aulakh, Brownstown Twp, MI (US); Norman Fasecas, Westland, MI (US)

Correspondence Address: MILLER LAW GROUP, PLLC;AND FORD GLOBAL TECHNOLOGIES, INC., 25 STEVENS AVENUE, WEST LAWN, PA, 19609, US

(73) Assignee: Ford Global Technologies, LLC

(21) Appl. No.: 11/415,909

(22) Filed: May 2, 2006

(51) Int. Cl. E06B 7/22

(52) U.S. Cl. 49/498.1

(57) ABSTRACT

An extruded automotive vehicle door seal provides for positional adjustment to establish an optimal sealing operation between the door and the frame against which the door closes. The structure of the door seal includes in cross section a base portion and a bulb portion. The frame against which the vehicle door closes is provided with a mounting channel into which the base portion of the adjustable door seal is seated. The base portion is preferably formed with a barbed periphery that frictionally engages the interior circumference of the mounting channel for positionally fixing the door seal relative to the vehicle frame. The position of the door seal is established by the closing of the door against the vehicle frame such that the bulb portion is engaged by the door and presses the base portion into the mounting channel to position the door seal in an optimal sealing position.

### FIELD OF THE INVENTION

This invention relates to an elastomeric seal carried by the door frame of a closure system, such as a door on an automotive vehicle, to seal the closure when the door is closed against the frame and, more particularly, to an adjustable seal that can increase the range over which the seal can be operative to accommodate different build variables in automobiles.

### BACKGROUND OF THE INVENTION

Many structures, such as aircraft, trains, automotive vehicles utilize doors or other closures mounted to the adjacent frame to permit access through the opening corresponding to the closure. One such particular instance of a sealed closure is the doors of an automotive vehicle. To keep wind noise and water from the exterior of the vehicle from entering the operator's compartment through the door opening, an elastomeric seal is provided between the movable door and the static frame. Thus, when the door is closed against the frame, the seal is compressed between the door and the frame to prevent the entry of water past the seal, which also serves to insulate the door opening from exterior noises.

The compression of the elastomeric door seal is influenced by many factors relating to the manufacturing process. Build variables, such as manufacturing tolerances and the addition of optional features, provide a substantial range for the gap between the door and the frame between which the seal must be operable. Preferably, the seal should be operable to accommodate the necessary range of sealing without increasing the force factor required to cause an effective compression of the elastomeric seal.

Accordingly, it would be desirable to provide an extruded elastomeric door seal that would allow the seal surface to conform to the gap between the door and the frame of the vehicle against which the door is to close.

### SUMMARY OF THE INVENTION

It is an object of this invention to overcome the aforementioned disadvantages of the known prior art by providing an adjustable extruded elastomeric door seal that can be mounted on an automotive vehicle door to conform to the door closing gap between the door and the frame of the vehicle against which the door is to close.

It is a feature of this invention that the positional adjustment of the door seal can be accomplished through a closure of the door against the vehicle frame.

It is an advantage of this invention that the optimum positioning of the seal between through utilization of a positionally adjustable seal increases the expectant life of the door seal.

It is another advantage of this invention that the optimal positioning of the vehicle door seal through the utilization of an adjustable door seal reduces door closure efforts.

It is still another advantage of this invention that the resetting of vehicle doors to position the vehicle door seal for optimal positioning thereof is no longer necessary.

It is another feature of this invention that the adjustable door seal can be fixed to the door through friction lock or through adhering techniques, including chemical bonding and thermal welding.

It is still another feature of this invention that the adjustable door seal can be seated within a mounting channel preferably formed as part of the vehicle frame against which the vehicle door closes.

It is another object of this invention to provide an adjustable vehicle door seal that is durable in construction, inexpensive of manufacture, carefree of maintenance, facile in assemblage, and simple and effective in use.

These and other objects, features and advantages are accomplished according to the instant invention by providing an extruded automotive vehicle door seal that can be positionally adjusted to establish an optimal sealing operation between the door and the frame against which the door closes. The structure of the door seal includes in cross section a base portion and a bulb portion. The frame against which the vehicle door closes is provided with a mounting channel into which the base portion of the adjustable door seal is seated. The base portion is preferably formed with a barbed periphery that frictionally engages the interior circumference of the mounting channel for positionally fixing the door seal relative to the vehicle frame. The position of the door seal is established by the closing of the door against the vehicle frame such that the bulb portion is engaged by the door and presses the base portion into the mounting channel to position the door seal in an optimal sealing position.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a right rear schematic perspective view of an automotive vehicle incorporating the principles of the instant invention;

FIG. 2 is an enlarged cross-sectional view of the door seal;

FIG. 3 is a partial cross-sectional view of the vehicle corresponding to lines 3-3 of FIG. 1 to depict the cross-sectional configuration of the adjustable door seal and the mounting channel in which the adjustable door seal is supported for sealing engagement with the adjacent vehicle frame;

FIG. 4 is a partial schematic perspective view of the door seal similar to that of FIG. 3, but showing the engagement of the vehicle frame against the bulb portion of the door seal to seat the base portion of the door seal in the mounting channel; and

FIG. 5 is a partial schematic perspective of the door seal similar to that of FIG. 4 but depicting a fully seated door seal due to the slammed closure of the door against the adjacent vehicle frame to optimally position the door seal.

### DETAILED DESCRIPTION OF THE PREFERRED EMBODIMENT

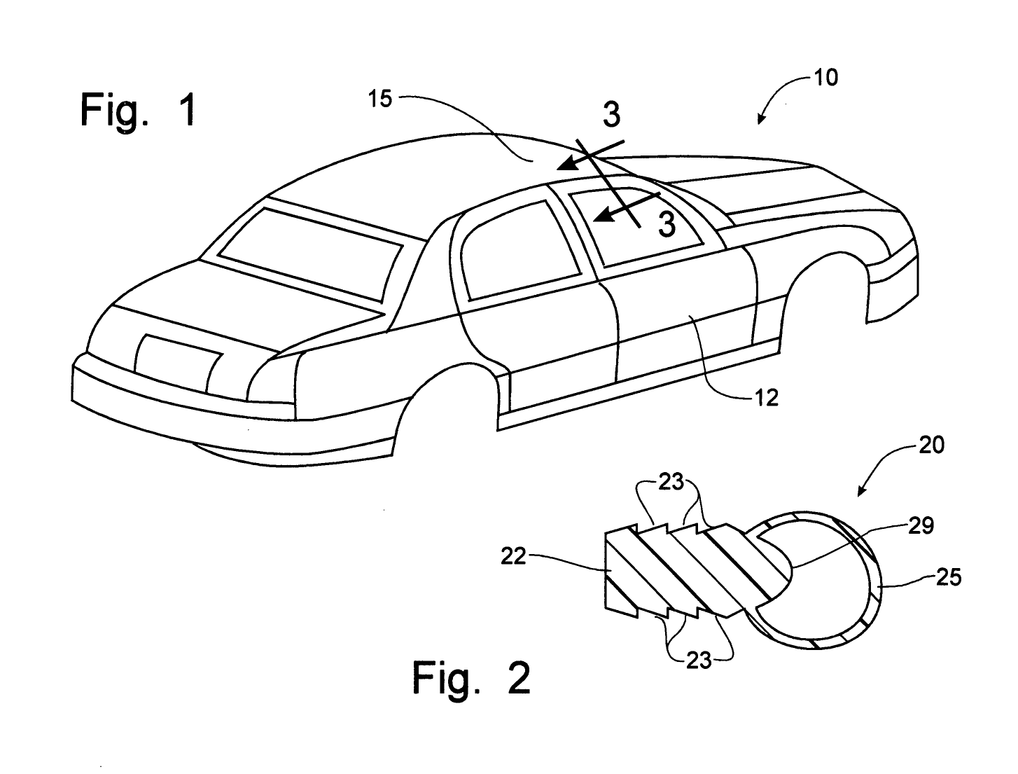

Referring to FIGS. 1-5, a representative automotive vehicle 10 having doors 12 closing against a vehicle frame 15 can be seen in which an adjustable door seal incorporating the principles of the instant invention closes the gap between the door 12 and the frame 15 to seal the interior operator's compartment from water and wind. Any left and right references are used as a matter of convenience and are determined by standing at the rear of the vehicle and facing forward into the normal direction of travel of the vehicle.

One skilled in the art will recognize that a sealed closure, such as the door to an automobile, can be utilized in many different applications, including any doorway against which a door closes. Examples of such applications would include aircraft, trains, and other transportation vehicles. Appliances, such as refrigerators, stoves and microwaves, utilized sealed closures to provide a selectively openable entryway into the appliance. Windows and doors on static structures are also provided with seals to prevent the entry of wind, rain and debris through the opening when closed. Accordingly, one skilled in the art will recognize that the description of the preferred embodiment herein, i.e. that of a door on an automotive vehicle, is not limiting to the scope of application of the instant invention.

The elastomeric door seal 20 is positioned between the periphery of the door 12 and the corresponding adjacent frame 15 of the vehicle against which the door 12 closes. The door seal 12 is conventionally carried on either the frame 15 or on the door 12, but is preferably carried on the frame 15. In operation, the closure of the door 12 against the adjacent vehicle frame 15 compresses the elastomeric door seal 20 and creates a watertight seal around the periphery of the door 12 to prevent the passage of water or wind when the door 12 is closed against the frame 15. One of ordinary skill in the art will recognize that the manufacturing and assembly of the door 12 on the automotive frame 15 can result in variations in the size of the gap between the door 12 and the frame 15 when the door is completely closed. When such variations in the gap are outside the normal range of operation of the door seal, compensation is conventionally accomplished by resetting the door 12 so that the closure gap falls within the sealing range of the door seal 20. Such compensation operations require substantial amounts of time and are, therefore, expensive to incur.

The adjustable door seal 20 incorporating the principles of the instant invention is formed with a base portion 22 and a bulb portion 25. The frame 15 is preferably formed with a mounting channel 18 defining a receiving cup that encircles the frame opening that is closed by the door 12. The base portion 22 of the door seal 20 is basically rectangular in cross-section, but is formed with a plurality of barbs or serrations 23 projecting from the opposing sides of the exterior surface of the base portion 22 in such a manner that the base portion 22 can be moved easily into the receiving cup of the mounting channel 18 supporting the base portion 22, but not easily extracted from the mounting channel 18. The bulb portion 25 is integrally formed with the base portion 22 and projects outwardly therefrom for engagement by the door 12 when closed against the door seal 20. The elastomeric barbs or serrations 23 provide a frictional lock between the base portion 22 and the mounting channel 18 when the door seal 20 is installed within the mounting channel 18 and extend along the longitudinal length of the base portion 22. Preferably, the barbs 23 are continuous along the length of the base portion 22, but could be formed as non-continuous, individual members spaced along the length of the base portion 22. An inner bumper 29 projects from the base portion 22 into the interior of the bulb 25 to perform the function of setting the door seal 20, as will be described in greater detail below.

The door seal 20 is initially mounted in the mounting channel 18 with the base portion 22 received within the mounting channel 18 and the bulb portion 25 positioned for engagement by the closing door 12. As represented in FIG. 4, the door 12 is preferably slammed against the door seal 20 compressing the bulb portion 25 against the inner bumper 29 and thus transmitting force into the base portion 22 to push the base portion 22 deeper into the mounting channel 18 until the door 12 is completely closed and latched against the vehicle frame 15. The recovery of the position of the door 12 is reflected in FIG. 5 where the door seal 20 has been placed in the optimal position for sealing the gap between the door 12 and the frame 15 with the bulb being partially compressed. The barbs or serrations 23 retain the base portion 22 within the optimal position within the mounting channel 18; however, an application of adhesive or other chemical bonding agents, or the application of thermo welding materials to the base portion during the initial installation of the door seal 20 into the mounting channel 18 will allow the base portion to be bonded to the mounting channel 18 when the seal 20 is optimally positioned.

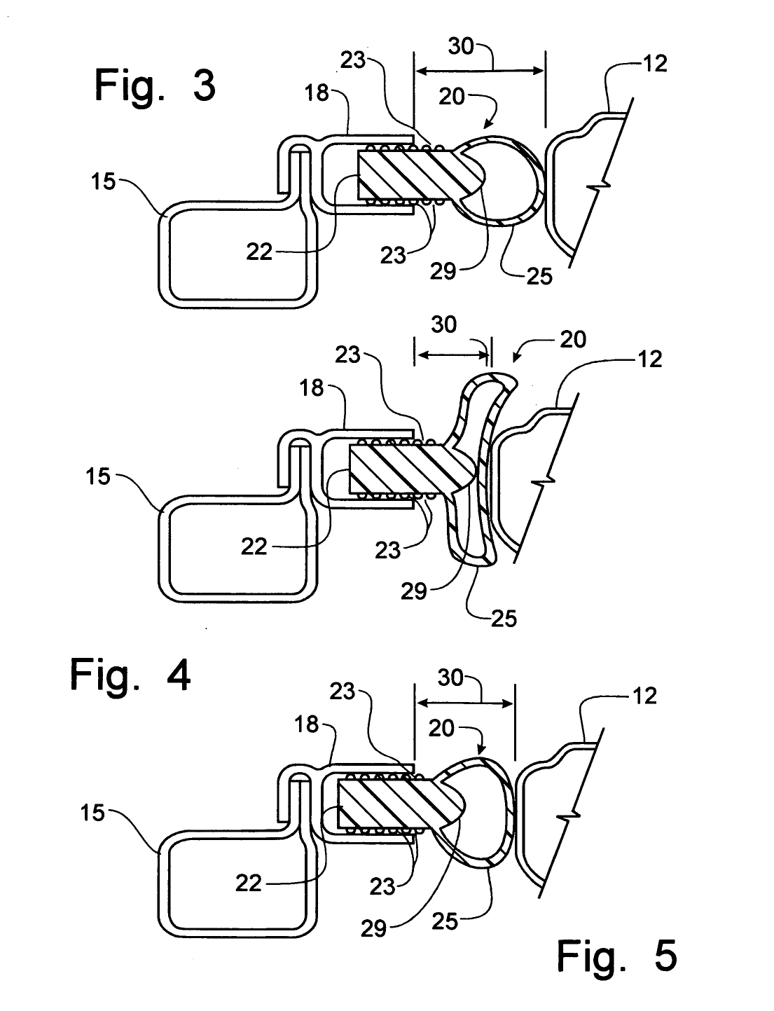

FIGS. 3-5 also reflect the range of sealing operations that the adjustable door seal 20 is capable of accommodating. In conventional door seals, the range of sealing operation is dictated by the amount of compression accepted within the bulb portion 25. In the door seal 20 incorporating the principles of the instant invention, the operative range is substantially greater than the range of compression of the bulb portion 25, and is enhanced by the amount of movement permitted to the base portion 22 within the mounting channel 18. Thus, the seal gap or closure gap 30 between the door 12 and the frame 15 is greater in FIG. 3 than when the base portion 22 is seated deeper in the mounting channel 18, as depicted in FIGS. 4 and 5. Furthermore, with conventional door seals, the over-compression of the bulb portion causes an abundance of wear within the door seal and shortens the life of the seal. In the adjustable door seal 20 incorporating the principles of the instant invention, the bulb portion 25 is only slightly compressed when the base portion is properly seated within the mounting channel 18 and, thus, the door seal 20 has an optimal operative life. Furthermore, the effort required to affect a sealed closure of the door 12 is less than the effort required to cause a greater compression of the bulb portion 25 of the door seal 20.

One skilled in the art will recognize that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention, however, concepts, as based upon the description, may be employed in other embodiments without departing from the scope of the invention.

For example, the adjustable door seal 20 described above is not limited to the preferred embodiment of a pivoted automotive door and can be utilized in a sliding door, such as is typically utilized on a van or minivan, or in conjunction with the rear door or hatch of a sport utility vehicle, or the trunk of an automotive vehicle.

Having thus described the invention, what is claimed is:

1. In an automotive vehicle having a frame defining a door opening and a door supported on the vehicle frame to close the door opening by moving the door adjacent to and generally parallel to said frame, the improvement comprising:
an adjustable door seal positioned between said door and said frame received within a seal holding member to be movable within said seal holding member to be positioned by the closure of the door against said door seal.

2. The automotive vehicle of claim 1 wherein said door seal comprises:
a base portion received within said seal holding member;
an integral bulb portion compressed by said door closure; and
an inner bumper projecting from said base portion internally of said bulb portion so that a deep compression of said bulb portion will press against said inner bumper and cause movement of said base portion within said seal holding member.

3. The automotive vehicle of claim 2 wherein said base portion is formed with serrations projecting outwardly from said base portion for engagement with said seal holding device.

4. The automotive vehicle of claim 3 wherein said seal holding member is a mounting channel defining a receptacle for receiving said base portion.

5. The automotive vehicle of claim 4 wherein said mounting channel is formed as part of the frame so that said door moves into engagement with said door seal upon closure against said frame.

6. The automotive vehicle of claim 5 wherein said serrations extend continuously along said base portion.

7. The automotive vehicle of claim 5 wherein said door seal is adjustably positioned into an optimal sealing position by the closure of the door against said frame during the initial installation of said door seal, said door seal being secured in said optimal sealing position by adhering techniques.

8. The automotive vehicle of claim 5 wherein said adhering techniques include an adhesive applied to said base portion before being installed into said mounting channel.

9. A positionally adjustable door seal assembly for use between a door and a frame member against which said door closes except for a closure gap therebetween, comprising:
a seal holding member defining a receiving cup;
a base portion received within said receiving cup of said seal holding member, said base member including serrations projecting outwardly therefrom for frictionally engaging said seal holding member, said base portion being positionally movable within said receiving cup by said door closing against said frame into an optimal sealing position;
a bulb portion compressible by the closure of said door against said frame to seal said closure gap; and
an inner bumper projecting from said base portion internally of said bulb portion so that a compression of said bulb portion by the closure of said door can engage said inner bumper and cause said base portion to move into said seal holding member.

10. The door seal assembly of claim 9 wherein said bulb portion is integrally formed with said base portion.

11. The door seal assembly of claim 9 wherein said serrations extend continuously along said base portion.

12. The door seal assembly of claim 9 wherein said seal holding member is a mounting channel having a U-shaped configuration defining said receiving cup.

13. The door seal assembly of claim 12 wherein said mounting channel is formed on said frame so that said bulb portion is engaged by said door upon closure thereof against said frame.

14. The door seal assembly of claim 13 wherein said door seal is adjustably positioned into said optimal sealing position by the closure of the door against said frame during the initial installation of said door seal, said door seal being secured in said optimal sealing position by adhesives.

15. A method of installing a closure seal for a structure having an opening against which a closure member engages to close the opening against the closure seal comprising the steps of
mounting said closure member on a frame of said structure for movement between an open position and a closed position;
providing a seal holding member defining a receiving cup between said closure member and said frame;
positioning a base member of said closure seal in said receiving cup of said seal holding member with a bulb portion projecting outwardly from said base portion for compression when said closure member moves into said closed position, said base portion being positioned such that said base portion has depth within said receiving cup for movement therewithin, and
closing said closure member against said frame to compress said bulb portion and cause said base portion to move within said receiving cup until said closure seal has reached an optimal sealing position within said seal holding member.

16. The method of claim 15 wherein said sealing holding member is a mounting channel formed on said frame so that said closure member engages said bulb portion when moved into said closed position.

17. The method of claim 15 wherein said closing step includes the step of deep compressing said bulb portion against an inner bumper extending from said base portion internally of said bulb portion to move said base portion within said receiving cup.

18. The method of claim 15 wherein said base portion is formed with serrations that frictionally engage said receiving cup to restrain said base portion at said optimal sealing position.

19. The method of claim 18 further comprising the step of applying an adhesive to said base portion prior to positioning step so that said adhesive will secure said base portion in said optimal sealing position after said closing step.

20. The method of claim 19 wherein said closure member is pivotally mounted on said frame by hinges and movable into said closed position by pivoting said closure member on said hinges.
